(19) United States
(12) Patent Application Publication
(10) Pub. No.: US 2020/0386374 A1
(43) Pub. Date: Dec. 10, 2020

(54) LED STRING LAMP, METHOD OF MANUFACTURING THE SAME, AND LED STRING LAMP SYSTEM

(71) Applicant: Shangyou Jiayi Lighting Product Co., Ltd., Ganzhou (CN)

(72) Inventor: Yaowen He, Ganzhou City (CN)

(21) Appl. No.: 16/946,083

(22) Filed: Jun. 5, 2020

(30) Foreign Application Priority Data
Jun. 6, 2019 (CN) 201920856440.5

(51) Int. Cl. F21S 4/26; F21V 23/06; F21V 23/00

(52) U.S. Cl. CPC F21S 4/26; F21Y 2115/10; F21V 23/003; F21V 23/06

(57) ABSTRACT

The present disclosure provides an LED string lamp and an LED string lamp system and relates to the technical field of control of LEDs, include a plurality of LED lamp beads, at least two cables and a controller, the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged; and the controller is configured to control light emission from the plurality of LED lamp beads by means of a direct current or alternating current. The present disclosure solves the technical problems of the LED lamps existing in the prior art which are controlled in a relatively single manner because they are wired in a relatively simple manner.

### CROSS-REFERENCE TO RELATED APPLICATION

This application claims priority to Chinese Patent Application No. 201920856440.5, filed with the Chinese Patent Office on Jun. 6, 2019, entitled “LED String Lamp and LED String Lamp System”, which is incorporated herein by reference in its entirety.

### TECHNICAL FIELD

The present disclosure relates to the technical field of lighting with LED lamps, and in particular to an LED string lamp (or light) and an LED string lamp system.

### BACKGROUND ART

At present, LED string lamps are used more and more in vehicles, buildings, electronic products and other fields, and the LED string lamps are also increasingly needed by the public. The current LED lamp strings have circuit structures connected in parallel or connected in series, and conducting wires and LEDs are encapsulated in encapsulants. Copper wire lamp strings are mostly common. During control, a power line connected to the positive electrode is controlled to output a high potential, and a power line connected to the negative electrode is controlled to output a low potential. The LED lamps are all connected in the same direction, and thus are controlled in a relatively simple manner and provide a relatively single function, which results in lower user experience. If additional functions are desired, it is necessary to use lamp beads provided therein with chips to obtain some additional functions and effects, which will increase the cost.

### SUMMARY

The present disclosure provides an LED string lamp, comprising: a plurality of LED lamp beads, at least two cables, and a controller, wherein the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged;

the controller is configured to control light emission from the plurality of LED lamp beads by means of a direct current or alternating current.

The present disclosure provides an LED string lamp system, comprising: a remote control terminal and the LED string lamp according to any one of the above embodiments.

The present disclosure provides a method of manufacturing the LED string lamp, comprising connecting the controller to the at least two cables, and connecting the plurality of LED lamp beads to the at least two cables, wherein the plurality of LED lamp beads are connected in parallel to the at least two cables with positive electrodes and negative electrodes thereof alternately arranged.

### BRIEF DESCRIPTION OF DRAWINGS

In order to more clearly illustrate technical solutions of specific embodiments of the present disclosure or of the prior art, drawings required for use in the description of the specific embodiments or the prior art will be described briefly below. It is obvious that the drawings in the following description are merely illustrative of some, but not all embodiments of the present disclosure. It will be understood by those of ordinary skill in the art that other drawings can also be obtained from these drawings without any inventive effort.

FIG. 1 is a structural view of an LED string lamp according to an embodiment of the present disclosure;

FIG. 2 is a schematic view of alternating current according to an embodiment of the present disclosure;

FIG. 3 is a structural view of a three-wire four-way lamp string according to an embodiment of the present disclosure; and

FIG. 4 is a structural view of a three-wire six-way lamp string according to an embodiment of the present disclosure.

Reference Numerals: 110: LED lamp bead; 120: controller; 130: first cable; 140:
second cable; 150: third cable; 1101: first LED lamp bead; 1102: second LED lamp bead; 1103: third LED lamp bead; 1104: fourth LED lamp bead; 1105: fifth LED lamp bead; 1106: sixth LED lamp bead.

### DETAILED DESCRIPTION OF EMBODIMENTS

The technical solutions of the present disclosure will be described below clearly and completely in connection with the embodiments. It is apparent that the embodiments to be described are some, but not all of the embodiments of the present disclosure. All the other embodiments obtained by those of ordinary skill in the art in light of the embodiments of the present disclosure without inventive efforts will fall within the scope of the present disclosure as claimed.

It should be noted that similar reference numerals and letters refer to similar items in the following figures, and thus once an item is defined in one figure, it may not be further defined or explained in the following figures.

Unless otherwise defined herein, the scientific and technical terms used in connection with the present disclosure shall have the meanings commonly understood by those of ordinary skill in the art. Exemplary methods and materials are described below, but methods and materials similar or equivalent to those described herein may also be used in the present disclosure.

In addition, the terms such as “first”, “second”, and “third”, if present, are used for distinguishing the description only, and should not be understood as an indication or implication of relative importance.

The object of the present disclosure includes, for example, providing LED string lamps and LED string lamp systems to solve the technical problems of the LED lamps existing in the prior art, which are controlled in a relatively single manner because they are wired in a relatively simple manner.

The present disclosure provides an LED string lamp, comprising: a plurality of LED lamp beads, at least two cables, and a controller, wherein the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged;

the controller is configured to control light emission from the plurality of LED lamp beads by means of a direct current or alternating current.

In one or more embodiments, every two of the plurality of LED lamp beads form an LED lamp bead group, the two LED lamp beads of the LED lamp bead group are arranged opposite to each other, a first opposite LED lamp bead of each LED lamp bead group has a positive electrode connected to the first cable and a negative electrode connected to the second cable, and a second opposite LED lamp bead of each LED lamp bead group has a positive electrode connected to the second cable and a negative electrode connected to the first cable.

In one or more embodiments, when there are two cables, two adjacent LED lamp beads of the plurality of LED lamp beads are arranged on the two cables, wherein the positive electrode of a first adjacent LED lamp bead is connected to the first cable, the negative electrode of the first adjacent LED lamp bead is connected to the second cable, the positive electrode of a second adjacent LED lamp bead is connected to the second cable, and the negative electrode of the second adjacent LED lamp bead is connected to the first cable.

In one or more embodiments, when there are three cables, the plurality of LED lamp beads are arranged on the three cables to form a three-wire four-way lamp string, and the plurality of LED lamp beads are connected to the three cables in such a manner that:

the positive electrode of a first LED lamp bead is connected to the second cable, and the negative electrode of the first LED lamp bead is connected to the first cable;

the positive electrode of a second LED lamp bead is connected to the second cable, and the negative electrode of the second LED lamp bead is connected to the third cable;

the positive electrode of a third LED lamp bead is connected to the first cable, and the negative electrode of the third LED lamp bead is connected to the second cable; and

the positive electrode of a fourth LED lamp bead is connected to the third cable, and the negative electrode of the fourth LED lamp bead is connected to the second cable.

In one or more embodiments, each LED lamp bead of the plurality of LED lamp beads includes two fillets, and the two fillets are configured to obtain electrical energy from the three cables, so as to supply power for the LED lamp beads.

In one or more embodiments, each LED lamp bead of the plurality of LED lamp beads has a size of (0.6 mm, 0.3 mm), or (0.8 mm, 0.5 mm), or (2.8 mm, 3.5 mm).

In one or more embodiments, when there are three cables, six LED lamp beads of the plurality of LED lamp beads are arranged on the three cables to form a three-wire six-way lamp string, and the plurality of LED lamp beads are connected to the three cables in such a manner that:

the positive electrode of a first LED lamp bead is connected to the second cable, and the negative electrode of the first LED lamp bead is connected to the first cable;

the positive electrode of a second LED lamp bead is connected to the second cable, and the negative electrode of the second LED lamp bead is connected to the third cable;

the positive electrode of a third LED lamp bead is connected to the first cable, and the negative electrode of the third LED lamp bead is connected to the second cable;

the positive electrode of a fourth LED lamp bead is connected to the third cable, and the negative electrode of the fourth LED lamp bead is connected to the second cable;

the positive electrode of a fifth LED lamp bead is connected to the first cable, and the negative electrode of the fifth LED lamp bead is connected to the third cable; and

the positive electrode of a sixth LED lamp bead is connected to the third cable, and the negative electrode of the sixth LED lamp bead is connected to the first cable.

In one or more embodiments, each LED lamp bead of the plurality of LED lamp beads includes three fillets, and the three fillets obtain electrical energy from the three cables, so as to supply power for the LED lamp beads.

In one or more embodiments, each LED lamp bead of the plurality of LED lamp beads has a size of (5 mm, 2.8 mm).

The present disclosure provides an LED string lamp system, comprising: a remote control terminal and the LED string lamp according to any one of the above embodiments.

The present disclosure provides a method of manufacturing the LED string lamp, comprising connecting the controller to the at least two cables, and connecting the plurality of LED lamp beads to the at least two cables, wherein the plurality of LED lamp beads are connected in parallel to the at least two cables with positive electrodes and negative electrodes thereof alternately arranged.

In one or more embodiments, every two of the plurality of LED lamp beads form an LED lamp bead group, the two LED lamp beads of the LED lamp bead group are arranged opposite to each other, a first opposite LED lamp bead of each LED lamp bead group has a positive electrode connected to the first cable and a negative electrode connected to the second cable, and a second opposite LED lamp bead of each LED lamp bead group has a positive electrode connected to the second cable and a negative electrode connected to the first cable.

In one or more embodiments, when there are two cables, two adjacent LED lamp beads of the plurality of LED lamp beads are arranged on the two cables, wherein the positive electrode of a first adjacent LED lamp bead is connected to the first cable, the negative electrode of the first adjacent LED lamp bead is connected to the second cable, the positive electrode of a second adjacent LED lamp bead is connected to the second cable, and the negative electrode of the second adjacent LED lamp bead is connected to the first cable.

In one or more embodiments, when there are three cables, the plurality of LED lamp beads are arranged on the three cables to form a three-wire four-way lamp string, and the plurality of LED lamp beads are connected to the three cables in such a manner that:
the positive electrode of a first LED lamp bead is connected to the second cable, and the negative electrode of the first LED lamp bead is connected to the first cable;

the positive electrode of a second LED lamp bead is connected to the second cable, and the negative electrode of the second LED lamp bead is connected to the third cable;

the positive electrode of a third LED lamp bead is connected to the first cable, and the negative electrode of the third LED lamp bead is connected to the second cable; and

the positive electrode of a fourth LED lamp bead is connected to the third cable, and the negative electrode of the fourth LED lamp bead is connected to the second cable.

In one or more embodiments, when there are three cables, six LED lamp beads of the plurality of LED lamp beads are arranged on the three cables to form a three-wire six-way lamp string, and the plurality of LED lamp beads are connected to the three cables in such a manner that:

the positive electrode of a first LED lamp bead is connected to the second cable, and the negative electrode of the first LED lamp bead is connected to the first cable;

the positive electrode of a second LED lamp bead is connected to the second cable, and the negative electrode of the second LED lamp bead is connected to the third cable;

the positive electrode of a third LED lamp bead is connected to the first cable, and the negative electrode of the third LED lamp bead is connected to the second cable;

the positive electrode of a fourth LED lamp bead is connected to the third cable, and the negative electrode of the fourth LED lamp bead is connected to the second cable;

the positive electrode of a fifth LED lamp bead is connected to the first cable, and the negative electrode of the fifth LED lamp bead is connected to the third cable; and

the positive electrode of a sixth LED lamp bead is connected to the third cable, and the negative electrode of the sixth LED lamp bead is connected to the first cable.

The LED string lamp and the LED string lamp system according to the present disclosure comprise a plurality of LED lamp beads, at least two cables, and a controller, wherein the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged; and the controller is configured to control light emission from the plurality of LED lamp beads by means of a direct current or alternating current. In the present disclosure, the positive and negative electrodes are connected in parallel in an alternate manner, so that the controller can control light emission from the LED lamp beads in two modes, and thus more control modes are provided, thereby solving the technical problems of the LED lamps existing in the prior art which are controlled in a relatively single manner because they are wired in a relatively simple manner, while avoiding an increase in cost caused by the use of lamp beads provided therein with chips.

It should be noted that the features in the embodiments of the present disclosure may be combined with each other without conflict.

In the prior art, a plurality of LED lamp beads are all connected in parallel, and the positive and negative electrodes of the plurality of LED lamp beads are connected in the same manner. As a result, during control, the LED lamp beads are controlled in a too simple manner and provide a relatively simple function, which results in lower user experience.

An LED string lamp and an LED string lamp system according to the present disclosure comprise a plurality of LED lamp beads, at least two cables, and a controller, the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged; and the controller is configured to control light emission from the plurality of LED lamp beads by means of a direct current (DC) or alternating current (AC). In the present disclosure, the positive and negative electrodes are connected in parallel in an alternate manner, so that the controller can control light emission from the LED lamp beads in two modes, and thus more control modes are provided, thereby solving the technical problems of the LED lamps existing in the prior art which are controlled in a relatively single manner because they are wired in a relatively simple manner, while avoiding an increase in cost caused by the use of lamp beads provided therein with chips.

The LED string lamp and the LED string lamp system according to the present disclosure will be described in detail below with reference to the drawings.

With reference to FIG. 1, an LED string lamp according to the present disclosure comprises: a plurality of LED lamp beads 110, at least two cables, and a controller 120, the controller 120 is connected to the at least two cables, and the plurality of LED lamp beads 110 are connected to the at least two cables.

Here, positive electrodes and negative electrodes of the plurality of LED lamp beads 110 are alternately connected in parallel to the at least two cables. The positive electrodes and the negative electrodes of the plurality of LED lamp beads 110 are alternately connected in parallel in a manner as shown in FIG. 1. The at least two cables are described by taking two cables, i.e., a first cable 130 and a second cable 140, as an example. The plurality of LED lamp beads 110 are described by taking two lamp beads, i.e., the leftmost LED lamp bead and the other LED lamp bead, as an example. The positive electrode of one LED lamp bead 110 is electrically connected to the first cable 130 and the negative electrode of the one LED lamp bead 110 is electrically connected to the second cable 140, and the negative electrode of the other LED lamp bead 110 is electrically connected to the first cable 130 and the positive electrode of the other LED lamp bead 110 is electrically connected to the second cable 140. It can be seen that the two LED lamp beads 110 are connected in such a manner that the positive electrodes and the negative electrodes of the plurality of LED lamp beads 110 are alternately connected in parallel. Of course, FIG. 1 only shows that two adjacent LED lamp beads 110 have positive electrodes and negative electrodes connected in parallel in an alternate manner, and non-adjacent LED lamp beads 110 are also possible, and a plurality of LED lamp beads having positive and negative electrodes wired in different manners may be arranged between two LED lamp beads having positive and negative electrodes wired in the same manner, which is not specifically limited in the present disclosure.

Here, the controller 120 is configured to control light emission from the plurality of LED lamp beads 110 by means of a direct current or alternating current.

Specifically, when the controller 120 outputs a direct current, for example, DC power of 4.5 V, a high voltage may be output from the first cable 130 and a low voltage may be output from the second cable 140, so that LED lamp beads 110 included in the plurality of LED lamp beads 110, which have positive electrodes electrically connected to the first cable 130 and negative electrodes electrically connected to the second cable 140, may emit light. On the contrary, when the controller 120 outputs a direct current, a high voltage may be output from the second cable 140 and a low voltage may be output from the first cable 130, so that LED lamp beads 110 included in the plurality of LED lamp beads 110, which have positive electrodes electrically connected to the second cable 140 and negative electrodes electrically connected to the first cable 130, may emit light.

Therefore, when the controller 120 outputs a direct current, the plurality of LED lamp beads 110 in the LED string lamp of the present disclosure can emit light in different control modes, whereby the LED string lamp of the present disclosure has increased applicability and is applicable over an extended range with extended application prospects.

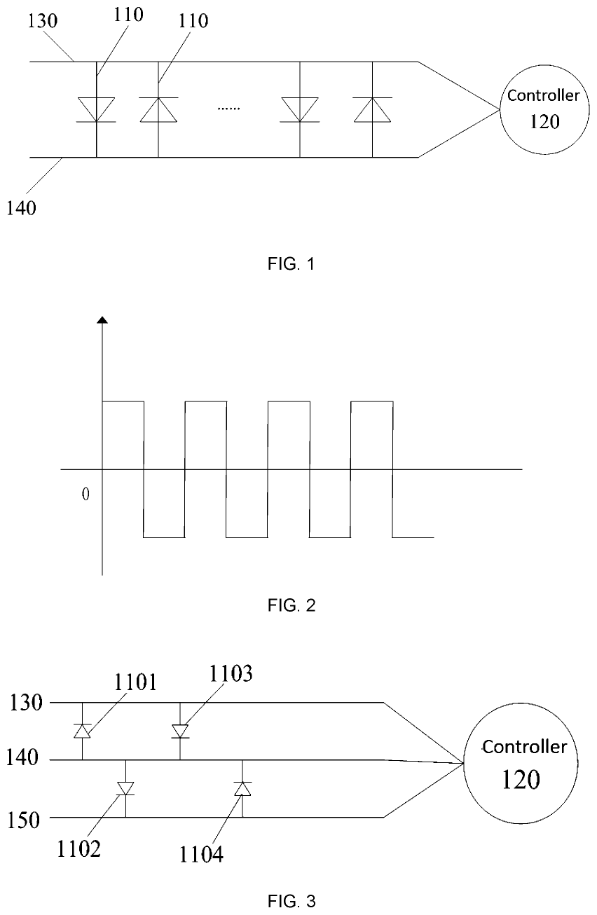

With reference to FIG. 2, a schematic view of alternating current is shown. When the controller 120 outputs alternating current, firstly a high voltage may be output from the first cable 130 and a low voltage may be output from the second cable 140, so that LED lamp beads 110 included in the plurality of LED lamp beads 110, which have positive electrodes electrically connected to the first cable 130 and negative electrodes electrically connected to the second cable 140, may emit light, and then a high voltage may be output from the second cable 140 and a low voltage may be output from the first cable 130, so that LED lamp beads 110 included in the plurality of LED lamp beads 110, which have positive electrodes electrically connected to the second cable 140 and negative electrodes electrically connected to the first cable 130, may emit light. In this way, the LED lamp beads 110 may be turned on alternately.

Therefore, when the controller 120 outputs an alternating current, the plurality of LED lamp beads 110 in the LED string lamp of the present disclosure can be alternately turned on and emit light at a preset frequency, whereby the LED string lamp of the present disclosure has increased applicability and is applicable over an extended range with extended application prospects.

In some embodiments, every two LED lamp beads of the plurality of LED lamp beads 110 are arranged opposite to each other at the same places of the two cables. In other words, every two of the plurality of LED lamp beads 110 form an LED lamp bead group, the two LED lamp beads of the LED lamp bead group are arranged opposite to each other, a first opposite LED lamp bead of each LED lamp bead group has a positive electrode connected to the first cable and a negative electrode connected to the second cable, and a second opposite LED lamp bead of each LED lamp bead group has a positive electrode connected to the second cable and a negative electrode connected to the first cable. In this way, when one LED lamp bead (e.g., the first opposite LED lamp bead) is damaged, other lamp beads (e.g., the second opposite LED lamp bead) can still emit light, whereby the luminous effect of the entire LED string lamp is not affected.

Optionally, when there are two cables, two adjacent LED lamp beads of the plurality of LED lamp beads 110 are arranged on the two cables, in order to allow the LED string lamp to be turned on more regularly. As shown in FIG. 1, the positive electrode of the first adjacent LED lamp bead is connected to the first cable, the negative electrode of the first adjacent LED lamp bead is connected to the second cable, the positive electrode of the second adjacent LED lamp bead is connected to the second cable, and the negative electrode of the second adjacent LED lamp bead is connected to the first cable.

With reference to FIG. 3, when there are three cables, the plurality of LED lamp beads are arranged on the three cables to form a three-wire four-way lamp string, wherein the plurality of LED lamp beads are connected to the three cables in such a manner that a three-wire four-way lamp string is formed. The LED lamp beads that can be connected in parallel to three cables are connected in four different connection methods, i.e., connection methods of a first LED lamp bead to a fourth LED lamp bead.

The positive electrode of the first LED lamp bead 1101 is connected to the second cable 140, and the negative electrode of the first LED lamp bead 1101 is connected to the first cable 130;

the positive electrode of the second LED lamp bead 1102 is connected to the second cable 140, and the negative electrode of the second LED lamp bead 1102 is connected to the third cable 150;

the positive electrode of the third LED lamp bead 1103 is connected to the first cable 130, and the negative electrode of the third LED lamp bead 1103 is connected to the second cable 140;

the positive electrode of the fourth LED lamp bead 1104 is connected to the third cable 150, and the negative electrode of the fourth LED lamp bead 1104 is connected to the second cable 140.

During the DC control by the controller 120, when the controller 120 transmits a high voltage to the first cable 130 and transmits a low voltage to the second cable 140, LED lamp beads included in the plurality of LED lamp beads 110 which are connected in the same manner as the third LED lamp bead 1103 may emit light; when the controller 120 transmits a high voltage to the second cable 140 and transmits a low voltage to the third cable 150, LED lamp beads included in the plurality of LED lamp beads 110 which are connected in the same manner as the second LED lamp bead 1102 may emit light; when the controller 120 transmits a high voltage to the second cable 140 and transmits a low voltage to the first cable 130, LED lamp beads included in the plurality of LED lamp beads 110 which are connected in the same manner as the first LED lamp bead 1101 may emit light; and when the controller 120 transmits a high voltage to the third cable 150 and transmits a low voltage to the second cable 140, LED lamp beads included in the plurality of LED lamp beads 110 which are connected in the same manner as the fourth LED lamp bead 1104 may emit light.

During the AC control by the controller 120, when the controller transmits alternating current to the first cable 130 and the second cable 140 and when the controller 120 transmits a high voltage to the first cable 130 and transmits a low voltage to the second cable 140, LED lamp beads included in the plurality of LED lamp beads 110 which are connected in the same manner as the third LED lamp bead 1103 may emit light. Then, when the controller transmits a high voltage to the second cable 140 and transmits a low voltage to the first cable 130, LED lamp beads included in the plurality of LED lamp beads 110 which are connected in the same manner as the first LED lamp bead 1101 may emit light. In this way, the LED lamp beads connected in different manners are enabled to emit light alternately.

During the AC control by the controller 120, when the controller transmits alternating current to the second cable 140 and the third cable 150 and when the controller 120 transmits a high voltage to the second cable 140 and transmits a low voltage to the third cable 150, LED lamp beads included in the plurality of LED lamp beads 110 which are connected in the same manner as the second LED lamp bead 1102 may emit light. Then, when the controller 120 transmits a high voltage to the third cable 150 and transmits a low voltage to the second cable 140, LED lamp beads included in the plurality of LED lamp beads 110 which are connected in the same manner as the fourth LED lamp bead 1104 may emit light. In this way, the LED lamp beads connected in different manners are enabled to emit light alternately.

Here, two fillets are included for each LED lamp bead of the plurality of LED lamp beads 110 in the three-wire four-way configuration, and the two fillets are configured to obtain electrical energy from the three cables, so as to supply power to the LED lamp beads.

Optionally, each LED lamp bead of the plurality of LED lamp beads 110 has a size of (0.6 mm, 0.3 mm), or (0.8 mm, 0.5 mm), or (2.8 mm, 3.5 mm), wherein the value preceding the comma in parentheses denotes a length, and the value following the comma denotes a width. In other words, the LED lamp bead has a length of 0.6 mm and a width of 0.3 mm, or the LED lamp bead has a length of 0.8 mm and a width of 0.5 mm, or the LED lamp bead has a length of 2.8 mm and a width of 3.5 mm.

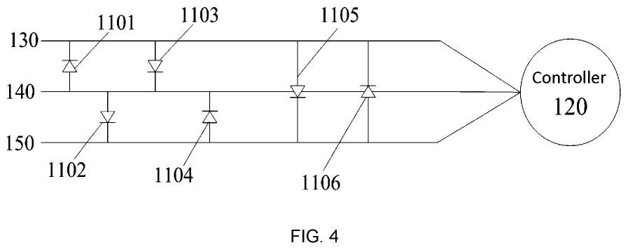

With reference to FIG. 4, when there are three cables, six LED lamp beads of the plurality of LED lamp beads 110 are arranged on the three cables to form a three-wire six-way lamp string. The plurality of LED lamp beads are connected to the three cables in such a manner that a three-wire six-way lamp string is formed. The LED lamp beads that can be connected in parallel to three cables are connected in six different connection modes, i.e., connection modes of a first LED lamp bead to a sixth LED lamp bead.

The positive electrode of the first LED lamp bead 1101 is connected to the second cable 140, and the negative electrode of the first LED lamp bead 1101 is connected to the first cable 130;

the positive electrode of the second LED lamp bead 1102 is connected to the second cable 140, and the negative electrode of the second LED lamp bead 1102 is connected to the third cable 150;

the positive electrode of the third LED lamp bead 1103 is connected to the first cable 130, and the negative electrode of the third LED lamp bead 1103 is connected to the second cable 140;

the positive electrode of the fourth LED lamp bead 1104 is connected to the third cable 150, and the negative electrode of the fourth LED lamp bead 1104 is connected to the second cable 140;

the positive electrode of the fifth LED lamp bead 1105 is connected to the first cable 130, and the negative electrode of the fifth LED lamp bead 1105 is connected to the third cable 150;

the positive electrode of the sixth LED lamp bead 1106 is connected to the third cable 150, and the negative electrode of the sixth LED lamp bead 1106 is connected to the first cable 130.

It can be seen that the three-wire six-way configuration is the same as the three-wire four-way configuration in four connection methods and different therefrom in that the positive electrode of the fifth LED lamp bead 1105 is connected to the first cable 130 and the negative electrode of the fifth LED lamp bead 1105 is connected to the third cable 150, and in that the positive electrode of the sixth LED lamp bead 1106 is connected to the third cable 150 and the negative electrode of the sixth LED lamp bead is connected to the first cable 130.

During the DC and AC control by the controller 120, the first to fourth LED lamp beads in the three-wire six-way configuration emit light in the same modes as those in the three-wire four-way configuration and can be specifically understood with reference to the description of the three-wire four-way configuration, and therefore will not be described in detail here.

The fifth and sixth LED lamp beads in the three-wire six-way configuration emit light in different modes from those in the three-wire four-way configuration. The specific light emission mode is as follows. During the DC control by the controller 120, when the controller 120 transmits a high voltage to the first cable 130 and transmits a low voltage to the third cable 150, LED lamp beads included in the plurality of LED lamp beads 110 which are connected in the same manner as the fifth LED lamp bead 1105 may emit light; and when the controller 120 transmits a high voltage to the third cable 150 and transmits a low voltage to the first cable 130, LED lamp beads included in the plurality of LED lamp beads 110 which are connected in the same manner as the sixth LED lamp bead 1106 may emit light.

During the AC control by the controller 120, when the controller 120 transmits alternating current to the first cable 130 and the third cable 150 and when the controller 120 transmits a high voltage to the first cable 130 and transmits a low voltage to the third cable 150, LED lamp beads included in the plurality of LED lamp beads 110 which are connected in the same manner as the fifth LED lamp bead 1105 may emit light. Then, when the controller transmits a high voltage to the third cable 150 and transmits a low voltage to the first cable 130, LED lamp beads included in the plurality of LED lamp beads 110 which are connected in the same manner as the sixth LED lamp bead 1106 may emit light. In this way, the LED lamp beads connected in different manners are enabled to emit light alternately.

Optionally, each LED lamp bead of the plurality of LED lamp beads 110 includes three fillets, and the three fillets obtain electrical energy from the three cables, so as to supply power to the LED lamp beads. The three fillets are connectors for supply of power from the cables to the interior of the LED lamp beads, and electric quantity can be input through each of the fillets.

Optionally, each LED lamp bead of the plurality of LED lamp beads 110 has a size of (5 mm, 2.8 mm). In other words, the LED lamp bead has a length of 5 mm and a width of 2.8 mm.

It can be seen that the LED lamp beads in the three-wire six-way configuration have a larger size than the LED lamp beads in the three-wire four-way configuration, thus the LED string lamp with the three-wire four-way configuration may be selected and used when a smaller LED string lamp is to be made as actually required.

Of course, there may also be four or more cables, which is not specifically limited in the present disclosure.

An LED string lamp system according to the present disclosure comprises a remote control terminal and the LED string lamp according to any one of the above embodiments.

The remote control terminal may control the operation of the controller of the LED string lamp based on control by a user, so that a plurality of LED lamp beads are turned on. Here, the remote control terminal may be a remote controller. The remote control terminal may have a selection function. The selection function may be DC control allowing the controller to control the LED lamp beads by a direct current, or may be AC control allowing the controller to control the LED lamp beads by an alternating current.

Finally, it should be noted that the above embodiments are merely intended to illustrate the technical solutions of the present disclosure, but not intended to limit the present disclosure. Although the present disclosure has been described in detail with reference to the foregoing embodiments, it should be understood by those of ordinary skill in the art that the technical solutions disclosed in the foregoing embodiments may still be modified, or some or all of the technical features thereof may be replaced with equivalents; and such modifications or replacements will not cause the essence of the corresponding technical solutions to depart from the scope of the technical solutions of the embodiments of the present disclosure.

### INDUSTRIAL APPLICABILITY

The present disclosure provides an LED string lamp and an LED string lamp system, comprising a plurality of LED lamp beads, at least two cables, and a controller, wherein the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged; and the controller is configured to control light emission from the plurality of LED lamp beads by means of a direct current or alternating current. In the present disclosure, the positive and negative electrodes are connected in parallel in an alternate manner, so that the controller can control light emission from the LED lamp beads in two modes, and thus more control modes are provided, thereby solving the technical problems of the LED lamps existing in the prior art which are controlled in a relatively single manner because they are wired in a relatively simple manner, while avoiding an increase in cost caused by the use of lamp beads provided therein with chips.

What is claimed is:

1. An LED string lamp, comprising: a plurality of LED lamp beads, at least two cables, and a controller, wherein the controller is connected to the at least two cables, and the plurality of LED lamp beads are connected to the at least two cables, wherein the plurality of LED lamp beads are connected in parallel to the at least two cables with positive electrodes and negative electrodes thereof alternately arranged; and
the controller is configured to control the plurality of LED lamp beads to emit light by means of a direct current or an alternating current.

2. The LED string lamp according to claim 1, wherein every two LED lamp beads of the plurality of LED lamp beads form an LED lamp bead group, wherein the two LED lamp beads of the LED lamp bead group are arranged opposite to each other, wherein a first opposite LED lamp bead of each LED lamp bead group has a positive electrode connected to a first cable and a negative electrode connected to a second cable, and a second opposite LED lamp bead of each LED lamp bead group has a positive electrode connected to the second cable and a negative electrode connected to the first cable.

3. The LED string lamp according to claim 1, wherein when two cables are provided, two adjacent LED lamp beads of the plurality of LED lamp beads are arranged on the two cables, wherein a positive electrode of a first adjacent LED lamp bead is connected to a first cable, a negative electrode of the first adjacent LED lamp bead is connected to a second cable, a positive electrode of a second adjacent LED lamp bead is connected to the second cable, and a negative electrode of the second adjacent LED lamp bead is connected to the first cable.

4. The LED string lamp according to claim 1, wherein when three cables are provided, the plurality of LED lamp beads are arranged on the three cables to form a three-wire four-way lamp string, and the plurality of LED lamp beads are connected to the three cables in such a manner that:
a positive electrode of a first LED lamp bead is connected to a second cable, and a negative electrode of the first LED lamp bead is connected to a first cable;
a positive electrode of a second LED lamp bead is connected to the second cable, and a negative electrode of the second LED lamp bead is connected to a third cable;
a positive electrode of a third LED lamp bead is connected to the first cable, and a negative electrode of the third LED lamp bead is connected to the second cable; and
a positive electrode of a fourth LED lamp bead is connected to the third cable, and a negative electrode of the fourth LED lamp bead is connected to the second cable.

5. The LED string lamp according to claim 4, wherein each LED lamp bead of the plurality of LED lamp beads comprises two fillets, wherein the two fillets are configured to obtain electrical energy from the three cables, so as to supply power to the plurality of LED lamp beads.

6. The LED string lamp according to claim 5, wherein each LED lamp bead of the plurality of LED lamp beads has a size of (0.6 mm, 0.3 mm), or (0.8 mm, 0.5 mm), or (2.8 mm, 3.5 mm).

7. The LED string lamp according to claim 1, wherein when three cables are provided, six LED lamp beads of the plurality of LED lamp beads are arranged on the three cables to form a three-wire six-way lamp string, and the plurality of LED lamp beads are connected to the three cables in such a manner that:
a positive electrode of a first LED lamp bead is connected to a second cable, and a negative electrode of the first LED lamp bead is connected to a first cable;
a positive electrode of a second LED lamp bead is connected to the second cable, and a negative electrode of the second LED lamp bead is connected to a third cable;
a positive electrode of a third LED lamp bead is connected to the first cable, and a negative electrode of the third LED lamp bead is connected to the second cable;
a positive electrode of a fourth LED lamp bead is connected to the third cable, and a negative electrode of the fourth LED lamp bead is connected to the second cable;
a positive electrode of a fifth LED lamp bead is connected to the first cable, and a negative electrode of the fifth LED lamp bead is connected to the third cable; and
a positive electrode of a sixth LED lamp bead is connected to the third cable, and a negative electrode of the sixth LED lamp bead is connected to the first cable.

8. The LED string lamp according to claim 7, wherein each LED lamp bead of the plurality of LED lamp beads comprises three fillets, wherein the three fillets obtain electrical energy from the three cables, so as to supply power to the plurality of LED lamp beads.

9. The LED string lamp according to claim 8, wherein each LED lamp bead of the plurality of LED lamp beads has a size of (5 mm, 2.8 mm).

10. An LED string lamp system, comprising: a remote control terminal and the LED string lamp according to claim 1.

11. The LED string lamp system according to claim 10, wherein the remote control terminal is a remote controller, and the remote control terminal has a selection function, wherein the selection function comprises DC control allowing the controller to control the plurality of LED lamp beads by a direct current, and AC control allowing the controller to control the plurality of LED lamp beads by an alternating current.

12. A method of manufacturing the LED string lamp according to claim 1, comprising connecting the controller to the at least two cables, and connecting the plurality of LED lamp beads to the at least two cables, wherein the plurality of LED lamp beads are connected in parallel to the at least two cables with positive electrodes and negative electrodes thereof alternately arranged.

13. The method according to claim 12, wherein every two LED lamp beads of the plurality of LED lamp beads form an LED lamp bead group, wherein the two LED lamp beads of the LED lamp bead group are arranged opposite to each other, wherein a first opposite LED lamp bead of each LED lamp bead group has a positive electrode connected to a first cable and a negative electrode connected to a second cable, and a second opposite LED lamp bead of each LED lamp bead group has a positive electrode connected to the second cable and a negative electrode connected to the first cable.

14. The method according to claim 12, wherein when two cables are provided, two adjacent LED lamp beads of the plurality of LED lamp beads are arranged on the two cables, wherein a positive electrode of a first adjacent LED lamp bead is connected to a first cable, a negative electrode of the first adjacent LED lamp bead is connected to a second cable, a positive electrode of a second adjacent LED lamp bead is connected to the second cable, and a negative electrode of the second adjacent LED lamp bead is connected to the first cable.

15. The method according to claim 12, wherein when three cables are provided, the plurality of LED lamp beads are arranged on the three cables to form a three-wire four-way lamp string, and the plurality of LED lamp beads are connected to the three cables in such a manner that:
a positive electrode of a first LED lamp bead is connected to a second cable, and a negative electrode of the first LED lamp bead is connected to a first cable;
a positive electrode of a second LED lamp bead is connected to the second cable, and a negative electrode of the second LED lamp bead is connected to a third cable;
a positive electrode of a third LED lamp bead is connected to the first cable, and a negative electrode of the third LED lamp bead is connected to the second cable; and
a positive electrode of a fourth LED lamp bead is connected to the third cable, and a negative electrode of the fourth LED lamp bead is connected to the second cable.

16. The method according to claim 12, wherein when three cables are provided, six LED lamp beads of the plurality of LED lamp beads are arranged on the three cables to form a three-wire six-way lamp string, and the plurality of LED lamp beads are connected to the three cables in such a manner that:
a positive electrode of a first LED lamp bead is connected to a second cable, and a negative electrode of the first LED lamp bead is connected to a first cable;
a positive electrode of a second LED lamp bead is connected to the second cable, and a negative electrode of the second LED lamp bead is connected to a third cable;
a positive electrode of a third LED lamp bead is connected to the first cable, and a negative electrode of the third LED lamp bead is connected to the second cable;
a positive electrode of a fourth LED lamp bead is connected to the third cable, and a negative electrode of the fourth LED lamp bead is connected to the second cable;
a positive electrode of a fifth LED lamp bead is connected to the first cable, and a negative electrode of the fifth LED lamp bead is connected to the third cable; and
a positive electrode of a sixth LED lamp bead is connected to the third cable, and a negative electrode of the sixth LED lamp bead is connected to the first cable.
